(19) United States
(12) Patent Application Publication
(10) Pub. No.: US 2004/0083392 A1
(43) Pub. Date: Apr. 29, 2004

(54) Digital information protecting method and system

(75) Inventors: Donald Yang, Taipei (TW); Chien-I Li, Taipei (TW)

Correspondence Address: TROXELL LAW OFFICE PLLC, SUITE 1404, 5205 LEESBURG PIKE, FALLS CHURCH, VA, 22041, US

(73) Assignee: NEOVUE Inc.

(21) Appl. No.: 10/689,596

(22) Filed: Oct. 22, 2003

(30) Foreign Application Priority Data
Oct. 25, 2002 (TW) 091124992

(51) Int. Cl. H04L 9/00

(52) U.S. Cl. 713/201

(57) ABSTRACT

This invention provides a digital information protecting method executed in an author and a client computer, both having a predetermined information processing software to process a piece of digital information. In the author computer, receive a content key from a server and encrypt the piece of digital information by the content key. Encrypt the content key by a predetermined key encrypting process. Transmit the encrypted information and encrypted content key to the client computer. In the client computer, decrypt the encrypted content key by a corresponding predetermined decrypting process. Decrypt the encrypted information by the content key so that the piece of digital information can be used by the client computer. No matter the client computer is on-line or off-line, it can get the key and decrypt the piece of digital information.

### BACKGROUND OF THE INVENTION

1. Field of the Invention

The present invention relates to digital information protecting method and system; and more particularly, to a method and system for double-encrypting digital information and the digital information can be decrypted and read whether on-line or off-line.

2. Description of the Prior Art

Because of the friendly operating interface and easy-to-use environment of the Internet, Internet users often unintentionally copy other people's works (such as articles, songs, and software) from Internet. Most of the authors publishing their works on Internet only wish to spread and popularize knowledge via Internet. However, some works are not even spread by the author themselves. These authors do not know their works are plagiarized by other people. Their rights have been invaded. These problems of violating copyright on Internet become more and more serious. Therefore, Digital Rights Management (DRM) technology is developed to solve these problems.

DRM is mainly used to control illegal spread digital information on Internet. Only the authorized users by the author can use the digital information according to the original range and date agreed by the author. Unauthorized users are not allowed to access the digital information. Authentica PageRecall and Alchemedia Mirage are two of the popular DRM softwares. However, the above DRM softwares still allow unauthorized users to download the encrypted digital information. Once the unauthorized users successfully decrypt the encrypted digital information, the digital information can still be read or used without proper authorization. In other words, the digital information is not protected by such DRM softwares at all.

In order to solve the above problem, U.S. Pat. No. 6,289,450 and U.S. Pat. No. 6,339,825 bring up the method that provide a policy to protect digital information from being accessed by unauthorized users.

But the prior art methods still have two disadvantages. First, when the DRM software encrypts the digital information, it only uses a simple one layer encryption method, and always adds the decrypt key in the encrypted digital information. So, users may use all kinds of methods to find out where the decrypt key is, and decrypt the encrypted digital information. Second, if the digital information isn't coded with decrypt key, users must download the decrypt key via Internet. However, the users may not be able to access to Internet at the time they wish to read the digital information. Therefore, it is very inconvenient.

### SUMMARY OF THE INVENTION

An objective of the present invention is to provide a double encrypt/decrypt method to protect digital information from being illegally used.

Another objective of the present invention is to provide a digital information protecting method to allow the information be read off-line.

In a preferred embodiment, the present invention is a digital information protecting method for encrypting a piece of digital information from an author computer with assistances from a server, and then transmitting an encrypted information to a client computer via a computer network for the client computer to decrypt the encrypted information to be used. Both the author computer and the client computer comprise a predetermined information processing software to process the piece of digital information. The method comprises the following steps performed in the author computer. Receive a content key from a server and encrypting the piece of digital information by the content key, encrypt the content key by a predetermined key encrypting process, and transmit the encrypted information and encrypted content key to the client computer. The method also comprises the following steps performed in the client computer. Decrypt the encrypted content key by a corresponding predetermined decrypting process, and decrypt the encrypted information by the content key to make the piece of digital information can be used by the client computer.

In other words, in addition to the usual single layer encryption, the present invention also encrypts the content and added the encrypted content key to the information. So the present invention can protect the information more effectively than the prior art.

The encrypt/decrypt keys of the present invention are stored in computer or in information process software or directly attached to the information. No necessary to download the decrypting key via Internet connection to proceed the decrypting process. So, users can use the information in off-line situation, increasing the convenience of using digital information, without decreasing the protection for the information.

The advantage and spirit of the invention may be understood by the following recitations together with the appended drawings.

### BRIEF DESCRIPTION OF THE APPENDED DRAWINGS

FIG. 1 is a schematic diagram of a digital information protecting system according to the present invention.

FIG. 2 is a diagram showing the operation of the author computer in FIG. 1.

FIG. 3 is a diagram showing the key encrypting process of the present invention.

FIG. 4 is a flow chart of the key encrypting process shown in FIG. 3.

FIG. 5 is diagram showing showing the operation of the client computer shown in FIG. 1.

FIG. 6 is a diagram showing the key decrypting process of the present invention.

FIG. 7 is a flow chart of the key decrypting process shown in FIG. 6

FIG. 8 is another digital information protecting system according to the present invention.

FIG. 9 is a flow chart of the digital information protecting method according to the present invention.

FIG. 10 is a schematic diagram of the third embodiment according to the present invention.

FIG. 11 is a diagram showing the key encrypting process of the third embodiment.

FIG. 12 shows the operation of the decryption procedure of the third embodiment in the present invention.

FIG. 13 is a flow chart of the digital information protecting method according to the third embodiment of the present invention.

### DETAILED DESCRIPTION OF THE INVENTION

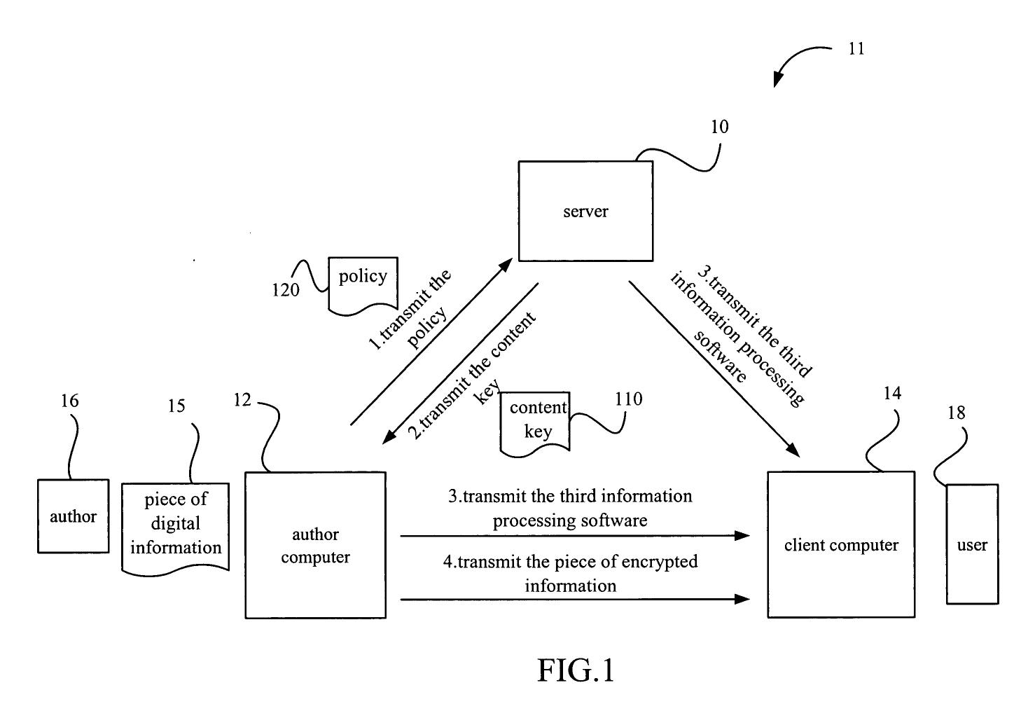

Referring to FIG. 1, FIG. 1 is a schematic diagram of a digital information protecting system 11 according to the present invention. The present invention provides digital information protecting system and method. The digital information protecting system 11 of the present invention is constructed among a server 10, an author computer 12 and a client computer 14. The digital information protecting system 11 is for encrypting a piece of digital information 15 from the author computer 12 with assistances from the server 10, and then transmitting an encrypted information to the client computer 14 via a computer network for the client computer 14 to decrypt the encrypted information to be used. Both the author computer 12 and the client computer 14 comprise a predetermined information processing software to process the piece of digital information 15.

The piece of digital information 15 can be electronic documents, e-mail, digital pictures, and video and so on. After the author 16 prepares the piece of digital information 15 in the author computer 12, the author computer 12 draws up a policy 120 with a first information processing software via the server and transmits the policy 120 to the server 10 via Internet. The policy 120 is the rules set up by the author 16 to regulate the piece of digital information 15. These rules comprise the authorization range, time, and using times of the piece of digital information 15, and the restriction for saving, coping, pasting, or printing.

The server 10 plays an assistant role in the embodiment according to the present invention. The server 10 is used to provide digital information processing software for the author computer 12 and the client computer 14. In addition, when receiving the policy 120 transmitted from the author computer 12, the software offers the client computer 12 a content key 110 for encrypting the piece of digital information 15.

If an user 18 needs to use the piece of digital information 15 from the client computer 14, the user 18 must download a second information processing software from the server 10, the author computer 12 or any computer system offers the second information processing software, and get the authorization from the author 16 to use the piece of digital information 15 according to the policy 120. The user 18 can download the piece of digital information 15 once he is authorized. Then, the user 18 can use the piece of digital information 15 after decrypting the piece of digital information 15 by the second information processing software.

In this embodiment, the information processing software encrypts/decrypts the piece of digital information 15 by AES (Advanced Encryption Standard) method. Because AES method can support 128 bits, even up to 256 bits, it has been acknowledged as one of the safest encrypting/decrypting calculation methods. Besides, all of the encrypting/decrypting methods of this embodiment are symmetric encrypting/decrypting methods. As a result, the encrypting key and the decrypting key are the same key. As to the first and second information processing software stored in the author computer 12 and the client computer 14, respectively, they are different back up copies of the same software in this embodiment, wherein the software module and key are the same but given different numbers to identify the information processing software installed in different computers.

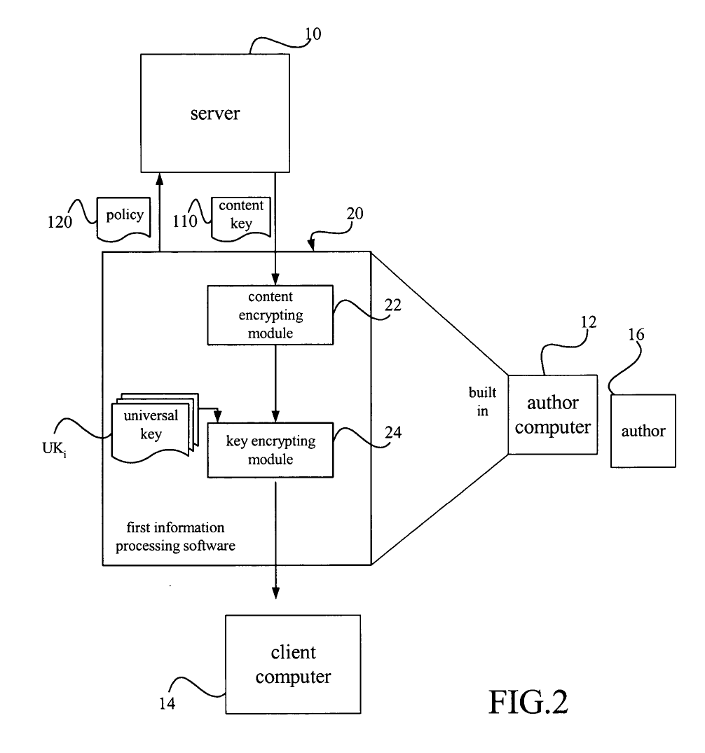

Referring to FIG. 2, FIG. 2 is a diagram showing the operation of the author computer 12 shown in FIG. 1. The application of the author computer 12 mainly protects the piece of digital information 15 by downloading the first information processing software 20 from the server 10 as an operating platform. In the author computer 12, the first information processing software 20 comprises a content encrypting module 22, a key encrypting module 24, and a plurality of universal keys UKi encoded with serial numbers. First, after the piece of digital information 15 is prepared, with the interface offered by the first information processing software 20 the author 16 sets up the policy 120 relating to the piece of digital information 15, for example the rules for accessing and using the piece of digital information 15. The policy 120 may comprise an Off-line Access Permission to permit the users to use the piece of digital information 15 in an off-line situation. Generally speaking, once getting Off-line Access Permission, the authorized users can use the piece of digital information 15 under not control from the author 16 and the server 10. Therefore, in order to enhance the protection for the piece of digital information 15, the system gives more restrictions when using the piece of digital information 15 in such off-line situation. For example, the piece of digital information 15 can only be read on the computer screen, but not be saved, printed . . . and so on.

After the author 16 draws up the policy 120, the first information processing software 20 transmits the policy 120 to the server 10. The server 10 transmits a content key 110 to the author computer 12 after receiving the policy 120.

After the policy 120 is drawn up, the content encrypting module 22 in the first information processing software 20 downloads the content key 110 from the server 10, and encrypts the piece of digital information 15 according to the content key 110. The piece of digital information 15 is encrypted by the content key 110 to become an piece of single encrypted digital information 48. Then, the key encrypting module 24 further encrypts the content key 110 according to a key encrypting process.

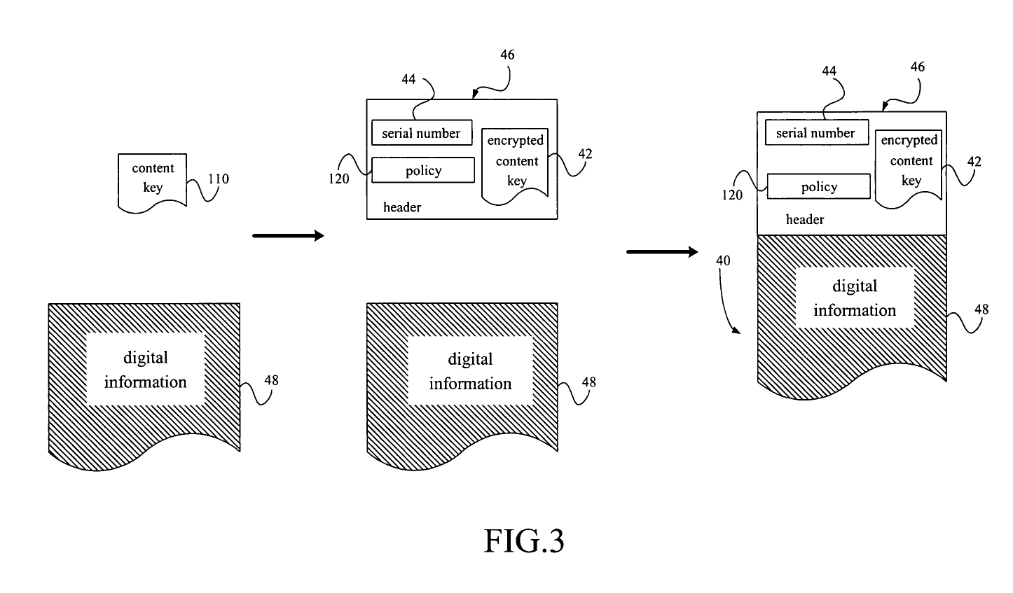

Referring to FIG. 3, FIG. 3 is a diagram showing the key encrypting process of the present invention. The key encrypting process is a stricter defense built up for the content key 110 and the piece of single encrypted digital information 48 in the present invention. First, the key encrypting module 24 needs to choose one UKi from the plurality of universal keys built in the first information processing software 20 to encrypt the content key 110, wherein every content key UKi has a corresponding serial number for identification. Then, the key encrypting module 24 stores the encrypted content key 42, the serial number 44 of the universal key, and the policy 120 to a header 46, and adds the header in front of the piece of single encrypted digital information 48. The policy 120 may be all or partially added into the header 46 according to the needs.

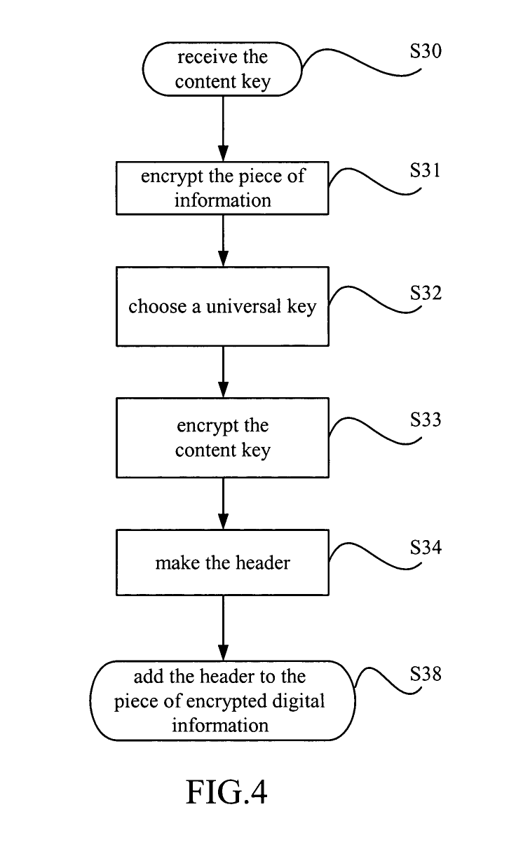

Referring to FIG. 4, FIG. 4 is a flow chart of the key encrypting process shown in FIG. 3. The key encrypting process is as a doubled encrypting process to add one more encryption to the single layer content encryption process of the prior art. The key encrypting process comprises the following steps:

Step S30: receive a content key 110.

Step S31: encrypt the piece of digital information 15 by using the content key 110 in order to produce the piece of single encrypted digital information 48.

Step S32: choose a universal key UKi.

Step S33: encrypt the content key 110 by using the chosen universal key UKi to become a encrypted content key 42.

Step S34: store the serial number 44 of the universal key UKi, the encrypted content key 42, and the policy 120 in the header 46.

Step S36: add the header 46 in front of the piece of single encrypted digital information 48.

After the step S36, the key encrypting process of the present invention is completed and the piece of digital information 15 becomes a piece of double encrypted digital information 40 (as shown in FIG. 3). After finishing double encrypting process for the piece of digital information 15 in the author computer 12, the author computer 12 spreads the piece of double encrypted digital information 40 by digital transmission. There are many ways of digital transmission for the client computer 18 to receive the piece of double encrypted digital information 40. The digital transmission may be through conventional floppy disks, optical disks, intranet, extranet, Internet, or other digital transmitting types.

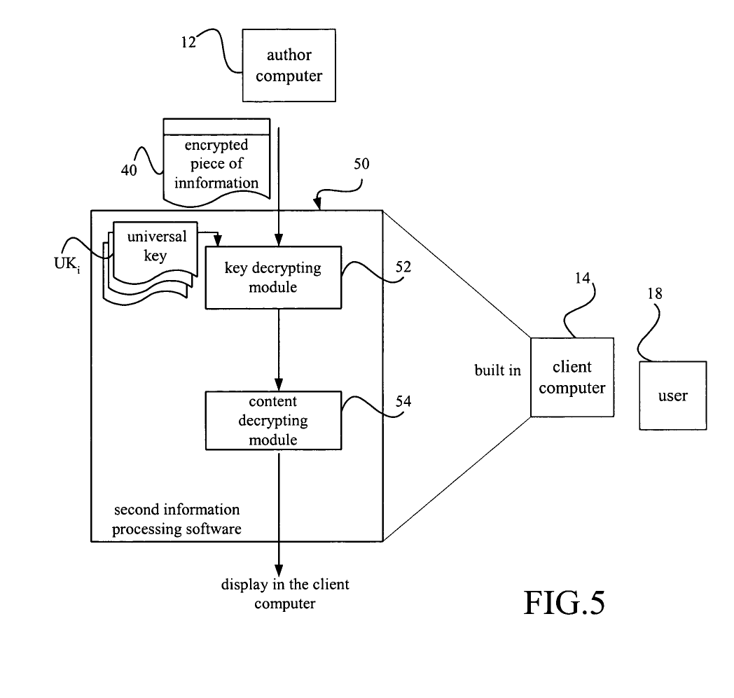

Referring to FIG. 5, FIG. 5 shows the operation of the client computer 14 shown in FIG. 1. If a user 18 wants to use the piece of double encrypted digital information 40 encrypted by the author computer 12, the user 18 must get the authorization to download the piece of double encrypted digital information 40. Besides getting the authorization from the author computer 12, the client computer 14 must download a second information processing software 50 to process the piece of double encrypted digital information 40. The second information processing software 50 comprises a key decrypting module 52 and a content decrypting module 54.

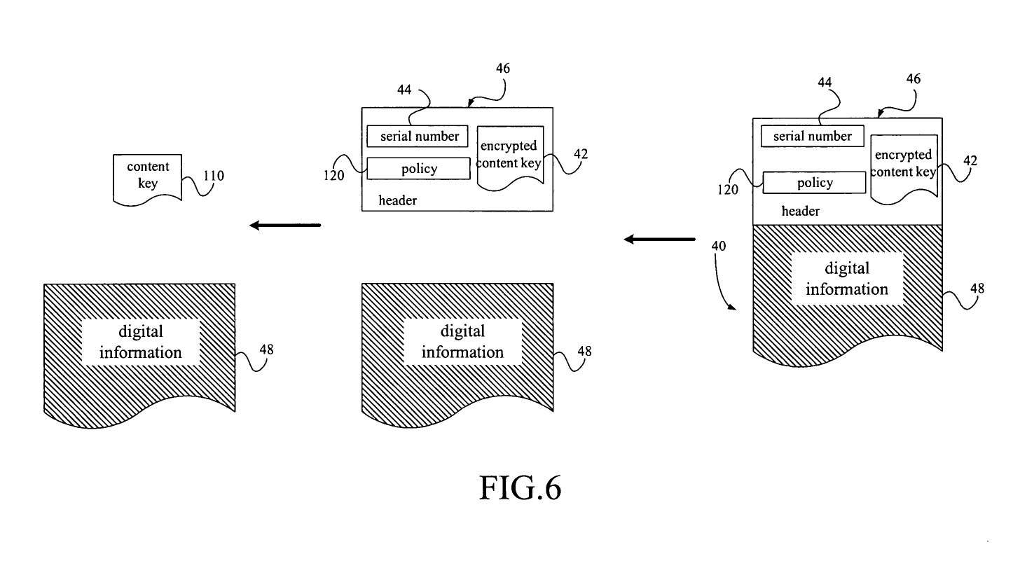

Referring to FIG. 6, FIG. 6 is a diagram showing the key decrypting process of the present invention. The second information processing software 50 is to decrypt the received piece of double encrypted digital information 40 by using the key decrypting module 52 with a key decrypting process. The key decrypting process is to find out a corresponding universal key UKi according to the serial number 44 stored in the header 46 and to decrypt the encrypted content key 42 by the universal key Uki, after the second information processing software 50 receives the piece of double encrypted digital information 40. Then, the content decrypting module 54 gets a content key 110 and decrypts the piece of single encrypted digital information 48 by the content key 110 in order to read and use the piece of digital information 15.

It needs to be noted that because all kinds of decrypting keys in the embodiment described above are stored in the authorized client computer 14, therefore, the user 18 can ask the author computer 12 to authorize an Off-line Access Permission if the user 18 wants to use the piece of digital information in an off-line situation. This Off-line Access permission is usually set up to be most restricted to clearly limit the using range and times to avoid the information been plagiarized by other people.

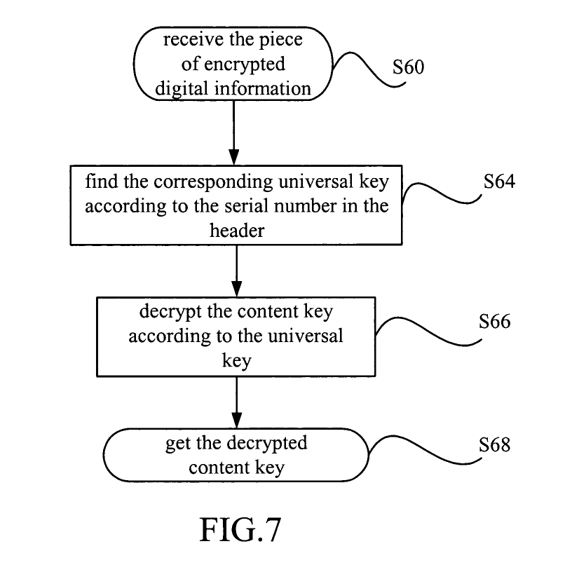

Referring to FIG. 7, FIG. 7 is a flow chart of the key decrypting process shown in FIG. 6. A key decrypting process is as a double decrypting process executed by the second information processing software 50 in the client computer 14. The key decrypting process comprises the following steps:

Step S60: receive the piece of double encrypted digital information 40.

Step S64: find the corresponding universal key UKi in the second information processing software according to the serial number 44 in the header 46.

Step S66: decrypt the content key 42 in the header 46 according to the universal key UKi.

Step S68: get the decrypted content key 110.

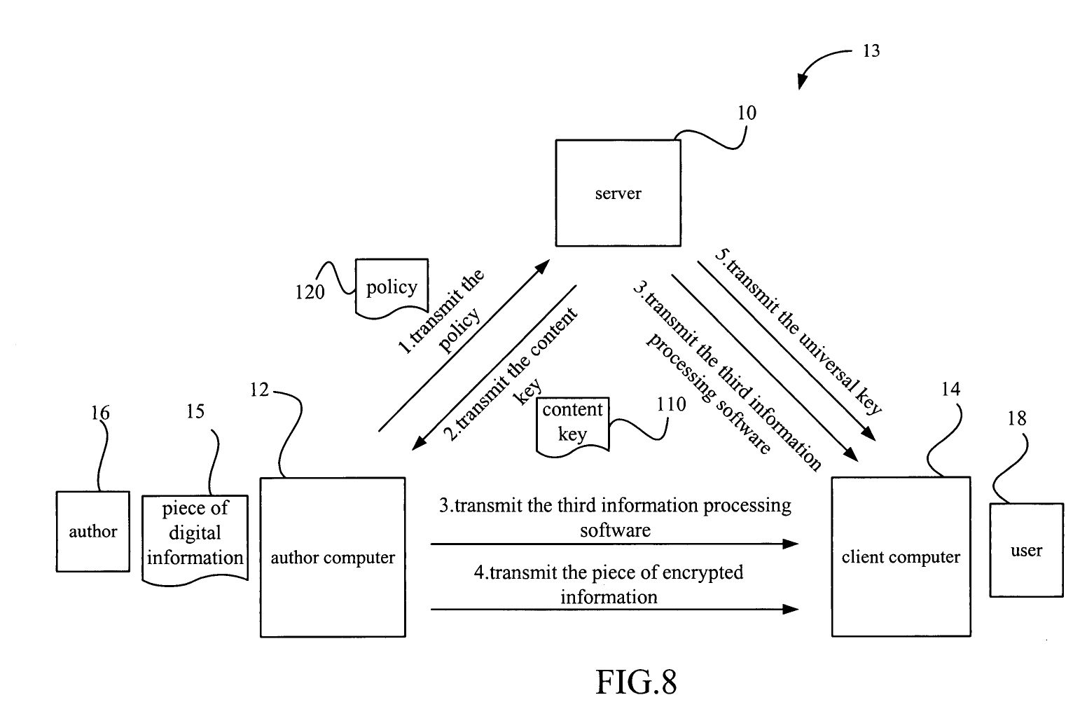

Referring to FIG. 8, FIG. 8 is another digital information protecting system 13 according to the present invention. The major difference between the system 13 shown in FIG. 8 and the system 11 shown in FIG. 1 is that in the system 13, a third information processing software 60 downloaded by the client computer 14 doesn't comprise a plurality of universal keys (UKi). So the user need to download the universal key UKi from the server 10 after receiving the piece of double encrypted digital information 40 according to the policy 120. When the third information processing software 60 in the client computer 14 gets the universal key UKi, following decrypting steps will be the same as the system 11 shown in FIG. 1.

There are many kinds of universal keys, such as symmetric and asymmetric encrypting/decrypting methods, used in the system 13. The symmetric encrypting/decrypting method has detail descripted in above, so following adds the description of the asymmetric encrypting/decrypting method applying in the system 13. Firstly, the author not only download the content key from the server, but also a public key of a universal key pair to encrypt the content key. Secondly, when the client proceeding the decryption, the client needs to download a private key of the universal key pair to decrypt the content key. Following decrypting steps will be the same as the system 11 shown in FIG. 1.

The server 10 plays an active assistant role in the system 13. The server 10 provids the information processing software to be used in the author computer 12 and the client computer 14. Moreover, when receiving the policy 120 from the author computer 12, the server 10 provids the author computer 12 the content key 110 for encrypting the piece of digital information 15. And finally, according to the policy 120, the server 10 provids the universal key to the third information processing software 60 in the client computer 14 to proceed following decrypting steps.

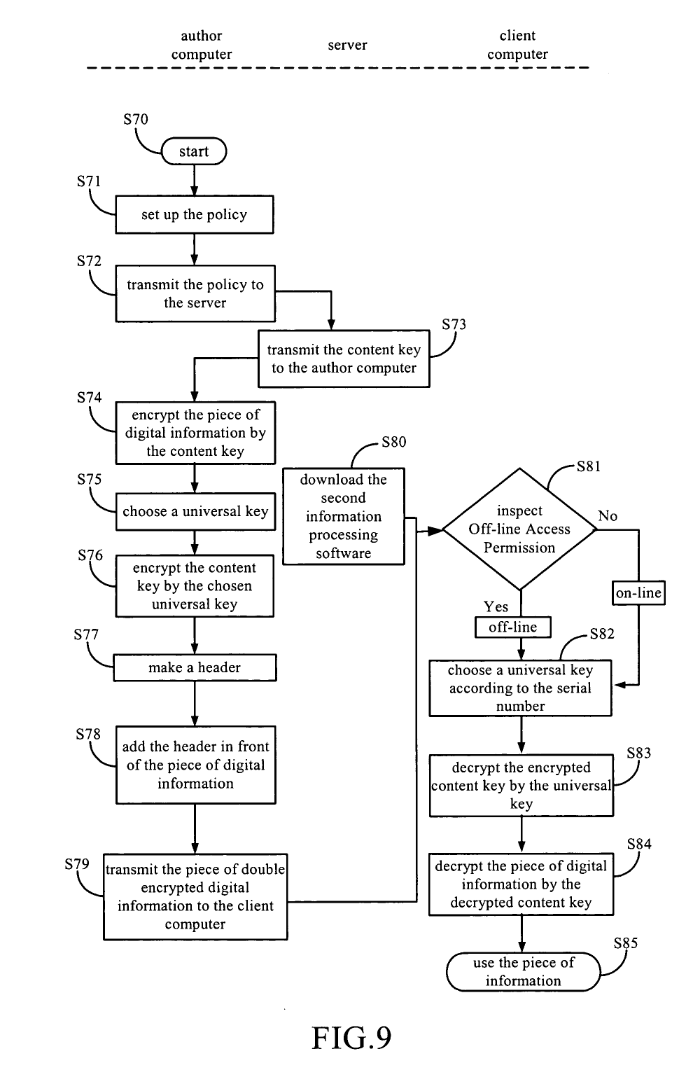

Referring to the FIG. 9, FIG. 9 is a flow chart of the digital information protecting method according to the present invention. The digital information protecting method of the present invention comprises the following steps:

Step S70: Start, the author 16 finishes preparing the piece of digital information 15 in the author computer 12.

Step S71: the author 16 sets up the policy 120 relating to the piece of digital information 15 with the first information processing software 20.

Step S72: transmit the policy 120 to the server 10.

Step S73: the server 10 transmits the content key 110 to the author computer 12.

Step S74: the first information processing software 20 encrypts the piece of digital information 15 by the content key 110.

Step S75: the first information processing software 20 chooses one key UKi from the plurality of universal keys.

Step S76: the first information processing software 20 encrypts the content key 110 by the chosen universal key UKi.

Step S77: the first information processing software 20 stores the encrypted content key 42, the serial number corresponding to the universal key UKi and the policy 120 to the header 46.

Step S78: the first information processing software 20 adds the header 46 in front of the piece of single encrypted digital information 48, and the piece of double encrypted digital information 40 is produced.

Step S79: transmit the piece of double encrypted digital information 40 to the client computer 14.

Step S80: the client computer 14 gets the authorization and downloads the second information processing software 50.

Step S81: inspect the decrypted header 46 to find out if there is an Off-line Access Permission authorized by the author 16. If yes, proceed step S82 in the off-line situation; if not, proceed step S82 in the on-line situation.

Step S82: choose a corresponding universal key UKi according to the serial number in the header 46.

Step S83: decrypt the encrypted content key 42 by the universal key UKi.

Step S84: decrypt the piece of single encrypted digital information 48 by the decrypted content key 110.

Step S85: use the piece of digital information 15 in the client computer 14.

In summary, the advantages of the first and the second embodiments in the present invention comprises the following points:

1. In addition to the usual encrypting method by using the content key to encrypt the piece of digital information, the present invention also uses the universal key to encrypt (and decrypts, on the other hand) the content key. The present invention not only protects the piece of digital information, but also protects the content key. So the present invention can protect the information more effectively than prior art.

2. The content key to the piece of digital information is added to the piece of encrypted digital information. As long as the user pass the policy, the piece of digital information can be used even in off-line situation, increasing the availability and usage of the digital information.

3. The plurality of universal keys in the information processing software are compiled in this software. Only if the whole software is completely broken down, the probability of getting the universal key is extremely low.

4. The content key is a necessary key to break into the information protected by the present invention. However, the content key is encrypted and delivered with the piece of encrypted digital information. And the serial number of the universal key and the universal key itself are needed in order to decrypt the content key. The present invention is designed to compile the universal key in the information processing software. Therefore, the complete information for encrypting/decrypting process are put in the piece of digital information and the software so that disperses the risk of breaking the piece of digital information, and increases the safety of the piece of digital information.

The following description will describe the third embodiment of this present invention. The third embodiment of this present invention protects the digital information by a fourth information processing software downloaded from the server. The fourth information processing software in the author computer comprises a content encrypting module and a key encrypting module.

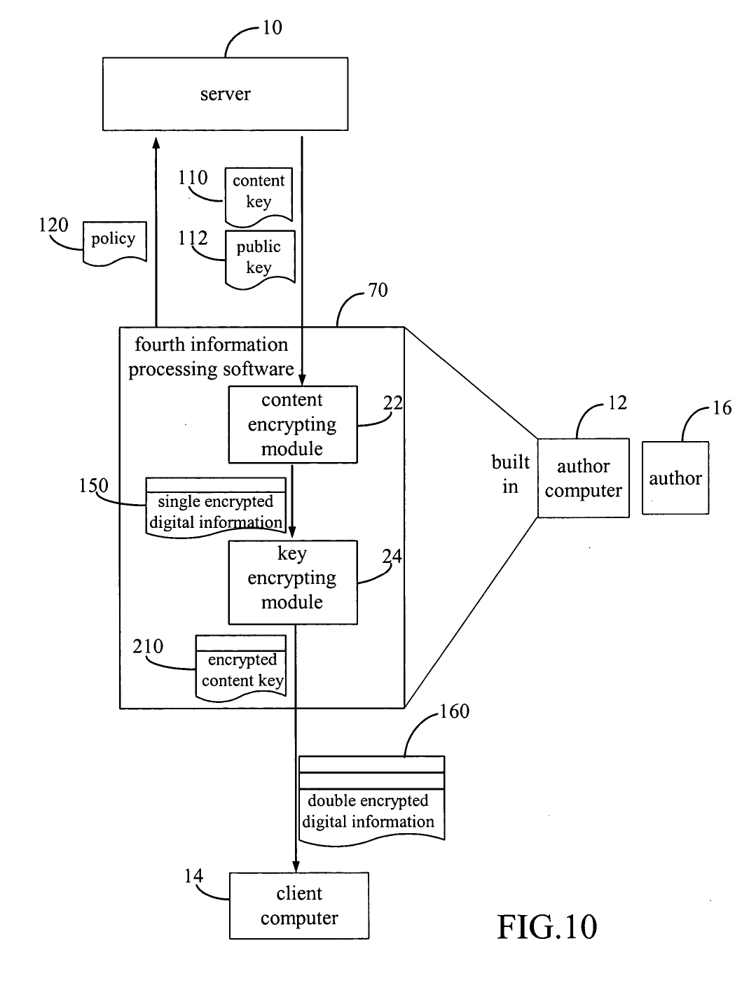

Please refer to FIG. 10. FIG. 10 is a schematic diagram of the third embodiment according to the present invention. First, after the piece of digital information 15 is prepared, with the interface provided by the fourth information processing software 70, the author 16 sets up the policy 120 to regulate the rules for accessing and using information 15. The policy 120 may comprise an Off-line Access Permission to permit the users to use digital information 15 in an off-line situation. This portion is the same as the first and the second embodiments.

After the author 16 draws up the policy 120, the fourth information processing software 70 transmits the policy 120 to the server 10. The content encrypting module 22 in the fourth information processing software 70 downloads the content key 110 from the server 10 and encrypts the piece of digital information 15 according to the content key 110 to be a piece of single encrypted digital information 150. It needs to be noted here that the content key 110 can also be produced by the author computer 12 itself or other software, not the server 10 only.

After that, the key encrypting module 24 further downloads a public key 112 to encrypt the content key 110 to be an encrypted content key 210. After this key encrypting processing finished, the piece of single encrypted digital information 150 becomes a piece of double encrypted digital information 160. Then, the author computer 12 transmits the piece of double encrypted digital information 160 and the encrypted content key 210 to the client computer 14.

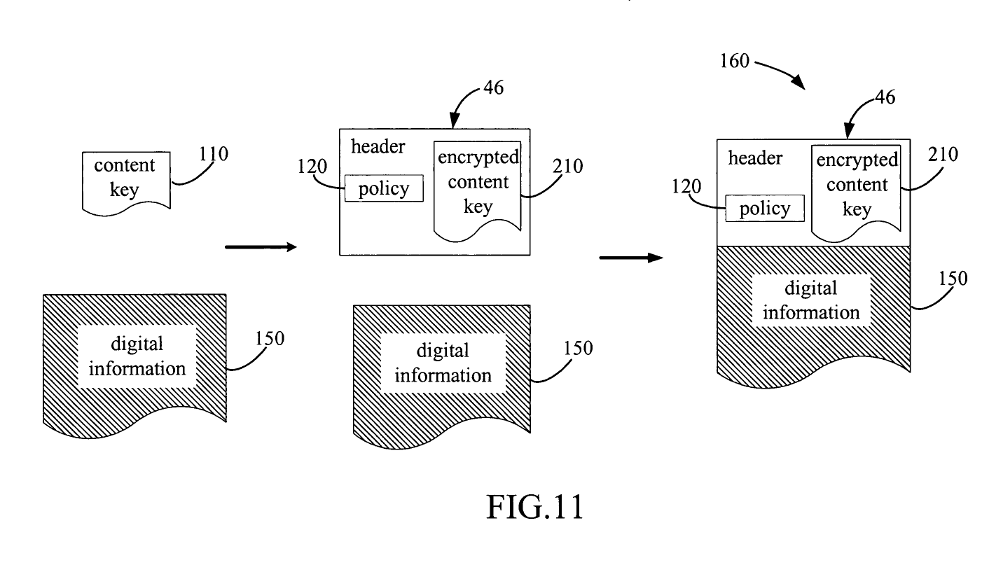

Referring to FIG. 11, FIG. 11 is a diagram showing the key encrypting process of the third embodiment. The key encrypting process is a stricter defense built up for the content key 110 and the piece of single encrypted digital information 150 in the present invention. First, the key encrypting module 24 encrypts the content key 110 by the downloaded public key 112, wherein every public key 112 has a corresponding private key 114 for the unique way of decrypting each public key 112. Then, the key encrypting module 24 stores the encrypted content key 210 and the policy 120 into a header 46, it then disposes the header 46 in front of the piece of single encrypted digital information 150. The policy 120 may be completely or partially added into the header 46 according to what is necessary. At this point, the key encrypting process of the present invention is completed, and the piece of digital information 15 becomes a piece of double encrypted digital information 160.

The public key 112 and the private key 114 of the server 10 are acquired from an issue device, wherein the issue device may be a trusted third party, a network software company, or even the server 10 itself.

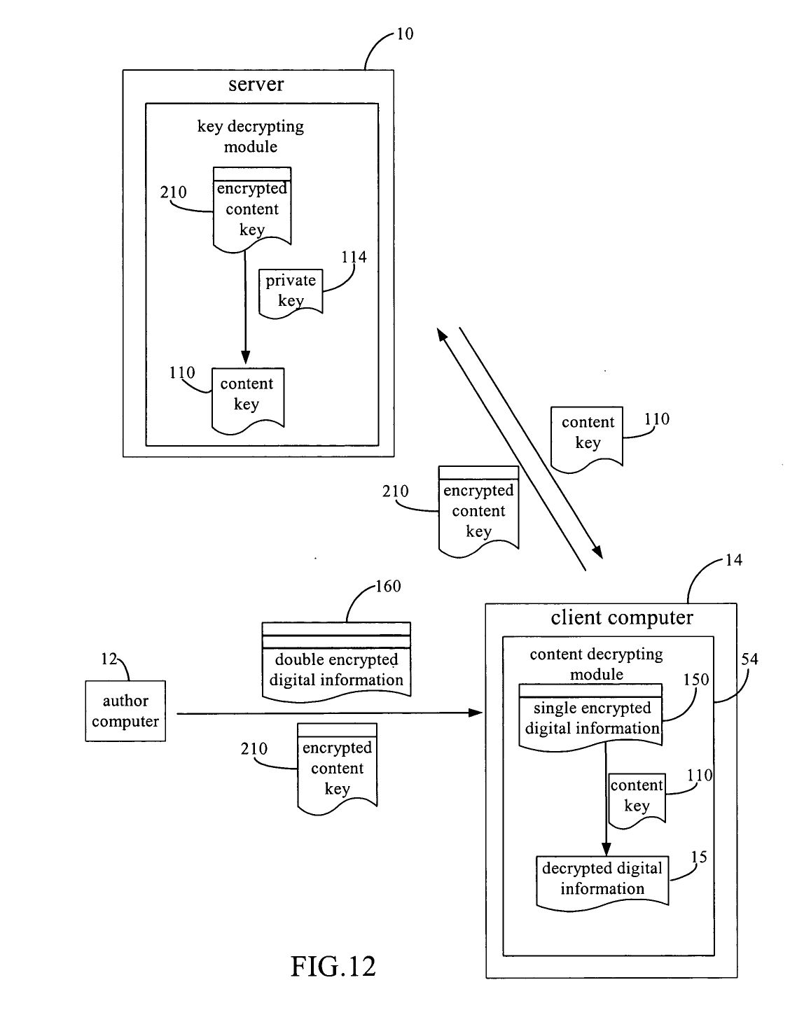

Referring to FIG. 12, FIG. 12 shows the operation of the decryption procedure of the third embodiment in the present invention. If a user 18 wants to use the piece of double encrypted digital information 160 encrypted by the author computer 12, the user 18 must get the authorization to download the piece of double encrypted digital information 160. Besides getting the authorization from the author computer 12, the client computer 14 must download a fifth information processing software (not shown in FIG. 12) from the server 10 to process the piece of double encrypted information 160.

First, the client computer 14 receives the piece of double encrypted digital information 160 and the encrypted content key 210 and transmits the encrypted content key 210 to the server 10; the server 10 comprises a key decrypting module 52. The key decrypting module 52 decrypts the encrypted content key 210 by the private key 114 corresponding to the public key 112 to the content key 110. Then, the server 10 transmits the decrypted content key 110 to the client computer 14. The fifth information processing software comprises a content decrypting module 54 which decrypts the single encrypted digital information 150 by the content key 110. After the decryption, the client computer 14 can use the piece of digital information 15.

The difference between the third embodiment and the first and second embodiments is that the first and second embodiments use a universal key to encrypt the content key, but the third embodiment uses a public key. In the third embodiment, the corresponding private key is needed for decryption. In the first and second embodiments, the decryption is processed in the client computer. In the third embodiment, the public key is decrypted in the server, and the client computer decrypts the content key only.

The method of the third embodiment has a higher security because the corresponding private key is not acquired easily. The RSA method is more difficult than the AES method for outsiders to break in for decryption.

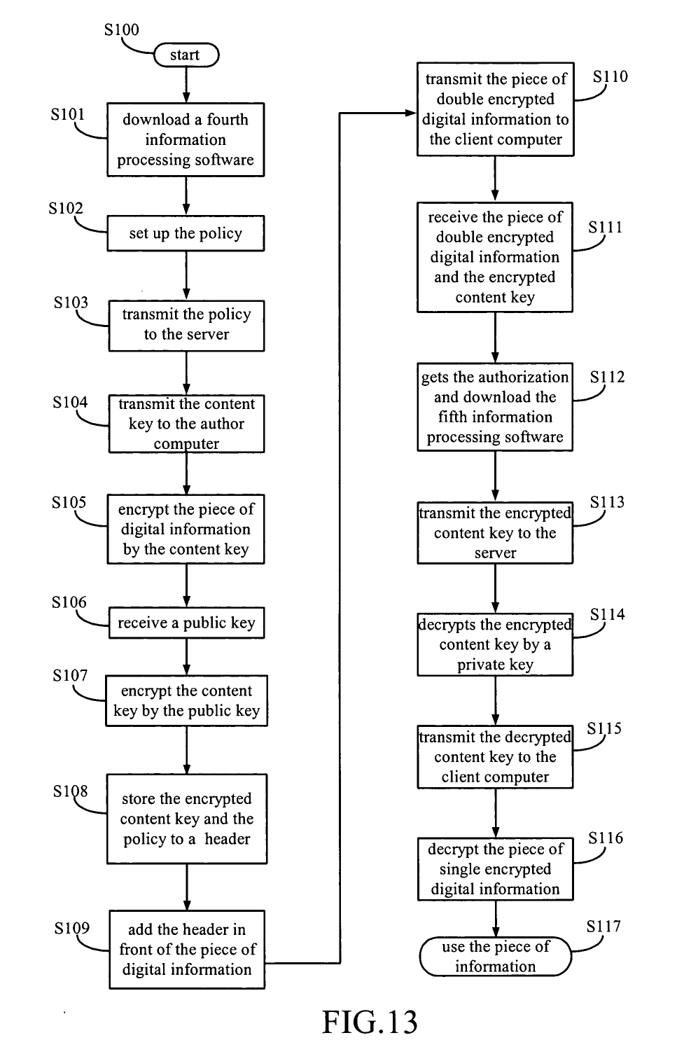

Referring to the FIG. 13, FIG. 13 is a flow chart of the digital information protecting method according to the third embodiment of the present invention. The digital information protecting method of the present invention comprises the following steps:

Step S100: Start; the author 16 finishes preparing the piece of digital information 15 in the author computer 12.

Step S101: the author computer 12 downloads a fourth information processing software 70.

Step S102: the author 16 sets up the policy 120 relating to the piece of digital information 15 with the fourth information processing software 70.

Step S103: transmit the policy 120 to the server 10.

Step S104: the server 10 transmits the content key 110 to the author computer 12.

Step S105: the fourth information processing software 70 encrypts the piece of digital information 15 by the content key.

Step S106: the fourth information processing software 70 receives a public key 112.

Step S107: the fourth information processing software 70 encrypts the content key 110 by the public key 112.

Step S108: the fourth information processing software 70 stores the encrypted content key 210 and the policy 120 to a header 46.

Step S109: the fourth information processing software 70 adds the header 46 in front of the piece of single encrypted digital information 150; and the piece of double encrypted digital information 160 is produced.

Step S110: transmit the piece of double encrypted digital information 160 and the encrypted content key 210 to the client computer 12.

Step S111: the client computer 14 receives the piece of double encrypted digital information 160 and the encrypted content key 210.

Step S112: the client computer 14 gets the authorization and downloads the fifth information processing software.

Step S113: the client computer 14 transmits the encrypted content key 210 to the server 10.

Step S114: the server 10 decrypts the encrypted content key 210, by a private key 114 corresponding to the public key 112, back to the decrypted content key 110.

Step S115: the server 10 transmits the decrypted content key 110 to the client computer 14.

Step S116: the client computer 14 decrypts the piece of single encrypted digital information 150.

Step S117: the client computer 14 can use the piece of digital information 15.

The third embodiment of this present invention is different from the first and second embodiment in two ways. First, the third embodiment doesn't use the universal key to encrypt the content key but the public key; second, the public key has a different way of decryption. In the first and second embodiments, the decryption is done according to the serial number to find the corresponding universal key to decrypt the encrypted content key. In the third embodiment, the public key is decrypted by a corresponding private key. Third, in the first and second embodiments, the content key and the universal key are encrypted and decrypted by the Advanced Encryption Standard (AES) method. In the third embodiment, the content key is still encrypted and decrypted by the AES method, but the public key and the private key are encrypted and decrypted by the Rivest Shamir Adleman (RSA) method.

In the third embodiment, the public key and the private key come from an issue device. The issue device may be belonged to a trusted third party or an organization that has the authority to issue this kind of key. Thus, the public key and the private key are a key pair. Outsiders cannot decrypt the key pair. The public key and the private key can also be issued by the server, and no one has anyway to know about it.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A digital information protecting method for encrypting a piece of digital information from an author computer with assistances from a server, and then transmitting an encrypted digital information to a client computer via a computer network for the client computer to decrypt the encrypted digital information to be used, both the author computer and the client computer comprising a predetermined information processing software to process the piece of digital information, the method comprising:
in the author computer:
receiving a content key from a server and encrypting the piece of digital information by the content key;
encrypting the content key by a predetermined key encrypting process; and
transmitting the encrypted digital information and the encrypted content key to the client computer; and
in the client computer:
decrypting the encrypted content key by a corresponding predetermined key decrypting process; and
decrypting the encrypted digital information by the content key to make the piece of digital information can be used by the client computer.

2. The digital information protecting method of claim 1, wherein the author computer draws up a policy relating to the piece of digital information, and transmits the policy to the server.

3. The digital information protecting method of claim 2, wherein the policy comprises the range, time, and using times of the piece of digital information being authorized.

4. The digital information protecting method of claim 1, wherein the information processing software of the author computer comprises a plurality of universal keys with encoded serial number.

5. The digital information protecting method of claim 4, wherein the key encrypting process is executed the following steps by the information processing software of the author computer:
choosing one of the plurality of universal keys, and encrypting the content key by the chosen universal key, and
storing the encrypted content key and the serial number of the universal key to a header, and adding the header in front of the encrypted digital information.

6. The digital information protecting method of claim 5, wherein before the information processing software of the author computer executes the key encrypting process, the software asks the author of the author computer to authorize an Off-line Access Permission.

7. The digital information protecting method of claim 6, wherein the Off-line Access Permission determines whether the client computer is permitted to process and use the received piece of digital information in the off-line situation.

8. The digital information protecting method of claim 7, wherein the key decrypting process is executed the following steps by the information processing software of the client computer:
getting a corresponding universal key according to serial number stored in the header; and
decrypting the content key by the universal key.

9. The digital information protecting method of claim 8, wherein the information processing software of the client computer downloads the universal key from the server according to the serial number.

10. The digital information protecting method of claim 8, wherein the information processing software of the client computer comprises a plurality of universal keys, the information processing software of the client computer chooses corresponding universal key according to the serial number.

11. The digital information protecting method of claim 1, wherein the information processing software encrypts and decrypts the piece of digital information by Advanced Encryption Standard (AES) method.

12. A digital information protecting system for encrypting a piece of digital information from an author computer with assistances from a server, and then transmitting an encrypted digital information to a client computer via a computer network for the client computer to decrypt the encrypted digital information to be used, both the author computer and the client computer comprising a predetermined information processing software to process the piece of digital information, the system comprising:
a first digital information process software, being set in the author computer, comprising:
a content encrypting module, for
receiving a content key from a server; and
encrypting the piece of digital information by the content key; and
a key encrypting module, for
encrypting the content key by a predetermined key encrypting process; and
transmitting the encrypted digital information and the encrypted content key to the client computer; and
a second information process software, setting in the client computer, comprising:
a key decrypting module, for
decrypting the encrypted content key by a corresponding predetermined decrypting process; and
a content decrypting module, for
decrypting the encrypted digital information by the content key to make the piece of digital information can be used by the client computer.

13. The digital information protecting system of claim 14, wherein the author computer draws up a policy relating to the piece of digital information, and transmits the policy to the server.

14. The digital information protecting system of claim 15, wherein the policy comprises the range, time, and using times of the piece of digital information being authorized.

15. The digital information protecting system of claim 14, wherein the information processing software of the author computer comprises a plurality of universal keys with encoded serial number.

16. The digital information protecting system of claim 17, wherein the key encrypting process is executed the following steps by the information processing software of the author computer:
choosing one of the plurality of universal keys, and encrypting the content key by the chosen universal key, and
storing the encrypted content key and the serial number of the universal key to a header, and adding the header in front of the encrypted digital information.

17. The digital information protecting system of claim 18, wherein before the information processing software of the author computer executes the key encrypting process, the software asks the author of the author computer to authorize an Off-line Access Permission.

18. The digital information protecting system of claim 19, wherein the Off-line Access Permission determines whether the client computer is permitted to process and use the received piece of digital information in the off-line situation.

19. The digital information protecting system of claim 20, wherein the key decrypting process is executed the following steps by the information processing software of the client computer:
getting a corresponding universal key according to serial number stored in the header; and
decrypting the content key by the universal key.

20. The digital information protecting method of claim 21, wherein the information processing software of the client computer downloads the universal key from the server according to the serial number, the information processing software of the client computer chooses corresponding universal key according to the serial number.

21. The digital information protecting method of claim 21, wherein the information processing software of the client computer comprises a plurality of universal keys.

22. The digital information protecting system of claim 14, wherein the information processing software encrypts and decrypts the piece of digital information by Advanced Encryption Standard (AES) method.

23. A digital information protecting method for encrypting a piece of digital information from an author computer with assistances from a server, and then transmitting an encrypted digital information to a client computer via a computer network for decrypting the encrypted digital information to be used, the method comprising:
in the author computer, encrypting the piece of digital information by a content key;
in the author computer, encrypting the content key by a public key;
in the author computer, transmitting the piece of encrypted digital information and the encrypted content key to the client computer;
in the client computer, receiving the piece of encrypted digital information and the encrypted content key;
in the client computer, transmitting the encrypted content key to the server;
in the server, decrypting the encrypted content key by a private key corresponding to the public key;
in the server, transmitting the decrypted content key to the client computer; and
in the client computer, decrypting the piece of encrypted digital information by the decrypted content key.

24. The digital information protecting method of claim 23, the author computer further draws up a policy relating to the piece of digital information, and transmits the policy to the server.

25. The digital information protecting method of claim 24, wherein the policy comprises the range, time, and using times of the piece of digital information being authorized.

26. The digital information protecting method of claim 23, wherein the server transmits the public key to the author computer.

27. The digital information protecting method of claim 26, wherein the public key transmitted from the server is acquired from an issue device.

28. The digital information protecting method of claim 27, wherein the encrypted content key are stored in a header, and added the header in front of the encrypted digital information.

29. The digital information protecting method of claim 28, wherein the content key is encrypted and decrypted by Advanced Encryption Standard (AES) method.

30. The digital information protecting method of claim 29, wherein the public key and the private key are encrypted and decrypted by Rivest Shamir Adleman (RSA) method.

31. A digital information protecting system for encrypting and decrypting a piece of digital information, the system comprising:
a content encrypting module, for using a content key to encrypt the piece of digital information;
a key encrypting module, for using a public key to encrypt the content key;
a key decrypting module, for decrypting the encrypted content key by a private key corresponding to the public key; and
a content decrypting module, for decrypting the piece of encrypted digital information by the content key.

32. The digital information protecting system of claim 31, wherein the content encrypting module and the key encrypting module are set in a author computer, and the content decrypting module is set in a client computer.

33. The digital information protecting system of claim 32, wherein the key decrypting module is set in a server.

34. The digital information protecting system of claim 33, the author computer further draws up a policy relating to the piece of digital information, and transmits the policy to the server.

35. The digital information protecting system of claim 34, wherein the policy comprises the range, time, and using times of the piece of digital information being authorized.

36. The digital information protecting method of claim 31, wherein the server transmits the public key to the author computer.

37. The digital information protecting method of claim 36, wherein the public key transmitted from the server is acquired from an issue device.

38. The digital information protecting method of claim 4, wherein the encrypted content key are stored in a header, and added the header in front of the encrypted digital information.

39. The digital information protecting method of claim 1, wherein the content key is encrypted and decrypted by Advanced Encryption Standard (AES) method.

40. The digital information protecting method of claim 1, wherein the public key and the private key are encrypted and decrypted by Rivest Shamir Adleman (RSA) method.
